(19) United States
(12) Patent Application Publication
(10) Pub. No.: US 2020/0136827 A1
(43) Pub. Date: Apr. 30, 2020

(54) METHOD AND APPARATUS FOR NETWORK SECURITY AND IDENTITY VERIFICATION

(71) Applicant: Crown Sterling Limited, LLC, Irvine, CA (US)

(72) Inventor: Joseph K. Hopkins, Ladera Ranch, CA (US)

(73) Assignee: Crown Sterling Limited, LLC, Irvine, CA (US)

(21) Appl. No.: 16/520,059

(22) Filed: Jul. 23, 2019

Related U.S. Application Data
(60) Provisional application No. 62/752,241, filed on Oct. 29, 2018.

(51) Int. Cl. H04L 9/32; H04L 29/06; H04L 29/08

(52) U.S. Cl. CPC H04L 9/3231; H04L 9/3247; H04L 67/306; H04L 63/0823; H04L 63/102; H04L 63/1425

(57) ABSTRACT

The method and apparatus for network security and identity verification operates on any suitable user computing devices such as smart watches, smart phones, tablets and computers and employs a primary personal key that is transmitted via the network to the security server where the primary personal key is compared to a secondary personal key held by the security server gatekeeper and if the primary and secondary personal keys are complimentary, they are combined to form a composite key. This composite key is used to access the user's dynamic key from the security database. The composite key along with the dynamic key are encoded and returned to the user device as verification of the user's identity. The combination of the composite key and the dynamic key are employed by the user's computing device to access the secure network or any suitable application on any other network.

This application claims priority to U.S. Provisional Application 62/752,241, filed Oct. 29, 2018.

### FIELD OF THE INVENTIONS

The inventions described below relate to the field of Network Security and Identity Verification.

### BACKGROUND OF THE INVENTIONS

Networks such as the internet and local area networks are vulnerable to unauthorized access via an authorized user's device that is equipped with conventional biodynamic security devices and simple password verifications.

### SUMMARY

The method and apparatus for network security and identity verification described below operates on any suitable user computing devices such as smart watches, smart phones, tablets and computers and employs a primary personal key that is transmitted via the network to the security server where the primary personal key is compared to a secondary personal key held by the security server gatekeeper and if the primary and secondary personal keys are complimentary, they are combined to form a composite key. This composite key is used to access the user's dynamic key from the security database. The composite key along with the dynamic key are encoded and returned to the user device as verification of the user's identity. The combination of the composite key and the dynamic key are employed by the user's computing device to access the secure network or any suitable application on any other network.

The user's personal key is composed of a digital signature and a biodynamic key. The digital signature is formed by a combination of alphanumeric characters representing for example, the user's full name, date of birth, day of birth and birth gender. The digital signature is combined with a biodynamic key that is created when the user passes one of two biodynamic evaluations. The first biodynamic evaluation is based on one or more of the motion, orientation or pressure sensor data that characterizes the user's use of the device. This collected biodynamic data from the first and second biodynamic evaluations is used to create the biodynamic key. The second biodynamic evaluation is based on pattern recognition data and it may be used if the user fails the first biodynamic evaluation or as an alternate to the first biodynamic evaluation. The pattern recognition data requires the user to enter a phrase or group of words. Each user enters the phrase differently and the motion and pressure sensors collect the pattern recognition data which is used to create the biodynamic key. The digital signature is a non-repudiation, non-repeatable multi-bit binary data string.

### BRIEF DESCRIPTION OF THE DRAWINGS

FIG. 1 is a block diagram of a network implementing the method and apparatus for network security and identity verification.

FIG. 2 is a flow chart of the method for network security and identity verification.

### DETAILED DESCRIPTION OF THE INVENTIONS

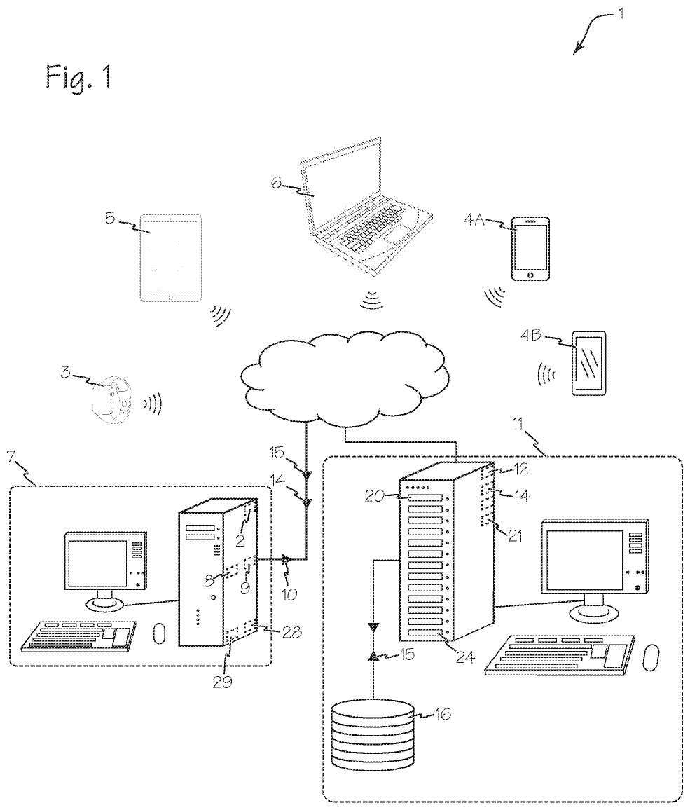

FIG. 1 is a block diagram of a network 1 implementing the method and apparatus for network security and identity verification. The network security and identity verification application 2 operates on any suitable user computing devices such as smart watch 3, smart phones 4, tablet 5 and computers 6 and 7 and employs a primary personal key 10 that is transmitted to the security server system 11 where the primary personal key 10 is compared to a secondary personal key 12 by the secure server gatekeeper/manager 20. The primary personal key and the secondary personal key are complimentary keys and they are combined to form a composite key 14. The composite key grants access the users dynamic key 15 from the security database 16. The composite key along with the dynamic key are encoded and returned to the network security application 2 on the user device. The combination of the composite key and the dynamic key verify the user's identity and enable the network security application 2 to access a secure network or any suitable server or application on network 1 or any other network.

The user's personal key 10 is composed of a fixed digital signature 8 and a biodynamic key 9. The digital signature 8 is formed using two or more of any suitable group of alphanumeric identifiers that are permanently associated with the user such as for example, a combination of alphanumeric characters representing the user's full name, the user's mother's maiden name, the user's mother or father's city of birth, the user's city of birth, the user's date of birth, the user's day of birth and/or the user's birth gender. The biodynamic key 9 is created when the user passes at least one biodynamic evaluation such as a first biodynamic evaluation that is based on motion, orientation and pressure sensor data 28 that characterizes the user's use of the device. Alternatively, a second biodynamic evaluation is based on the user's device pattern recognition data 29. The two biodynamic evaluations may be used together such that the user may be required to pass one of the two biodynamic evaluations and the second evaluation may be used if the user fails the first biodynamic evaluation or as an alternate to the first biodynamic evaluation. The user's device pattern recognition data 29 for the second biodynamic evaluation requires the user to enter one or more preselected phrases or groups of words. Each user enters the phrases differently in terms of their speed as well as the timing and pressure of keystrokes and the motion and pressure sensors collect the pattern recognition data separately for each device that the user uses to access the security application. The motion, orientation and pressure sensor data 28 and the device pattern recognition data are combined to create the biodynamic key 9. The digital signature is a non-repudiation, non-repeatable multi-bit binary data string.

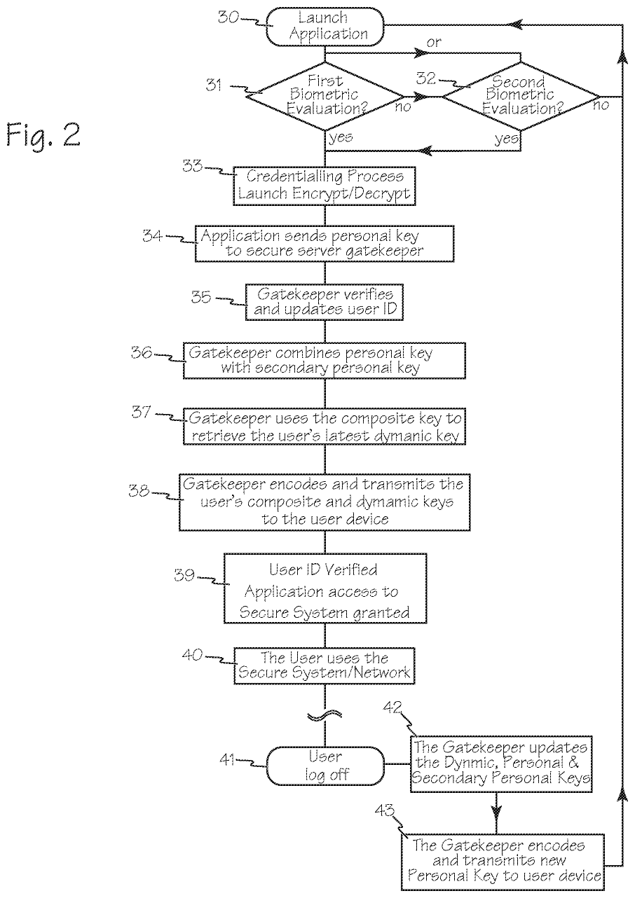

FIG. 2 is a flow chart of the method for network security and identity verification. Upon launch from a computing device, the credentialing process of step 33 initiates a dynamic pattern composition algorithm to complete the encryption/decryption key build to enable secure communication between the user device and the secure server. The encryption and decryption security pairing sequence is automatically generated for the user's personal key (digital signature) and authenticates using the biodynamic evaluations each time the user launches a computing device's web browser and/or standard operating system application is initiated.

The dynamic key is created by any suitable algorithm or network. Ideally, the dynamic key is created by a neural network such as neural network 25. The gatekeeper/manager 20 of the secure server system imports, converts and stores the user's device log data, all the user's network data and content into structured digital files, texts and images as user network data 21 which is organized to correspond to each user. Gatekeeper/manager 20 also compresses each user's network data 21 to form a thumbnail summary 22 for each user after each network session. The use of compressed thumbnail summaries for each user operates to anonymize the user data such that subsequent use by the neural network 25 cannot be traced backwards to the user.

The thumbnail summary 22 of each users data is provided to neural network 25 which uses each user's compressed thumbnail summary to generate the dynamic key 15 for the user based on the latest data from the users device and network actions. Thus, each user's dynamic key updates/changes every time the user accesses the network through the security app.

In addition to the thumbnail summaries 22 the system also collects activity dimensions 26 for each user. The activity dimensions 26 may be any suitable metrics representing the user's activity on network 1. For example, activity dimensions 26 may include the number of friends, followers or others users linked or associated with a user, it may also include the number of network sites visited or a number representing page visit durations, unique authoring instances (a numerical representation of unique content uploaded or entered to the network by the user, such as total bytes, a checksum for all uploaded content, etc.), the frequency and or duration of network usage and the user's device log file. Activity dimensions 26 may also be weighted for use by the neural network. Over time as the user interacts with a network such as network 1 through the network security application 2 the neural network 25 will modify/refine the user's behavioral pattern recognition learning from the compressed user network data 22 and the activity dimensions 26. Once the dynamic pattern composition algorithm sends the activity dimensions 26 to the gatekeeper/manager 20, the neural network 25 acts as a kind of virtual brain and it is changed (learns) by the activity dimensions 26 and it adds the activity dimensions to the database grouping system. This machine learning of the neutral network, capturing personalized attributes and patterns from the compressed thumbnail summaries 22 and the activity dimensions 26 adds complexities to the authentication security of the security application 2.

As the neural network user pattern composition recognitions become mature, the security application is algorithmically programmed (based on the compiled compressed thumbnail summaries 22 and the activity dimensions 26) to randomly select and apply a combination sequence of the last log of recorded occurrences of both local and Internet public forum activity dimensions. This combination sequence is a compounding effect that takes differing portions of each activity dimension component and applies any suitable mathematical formula to the neutral network output to complete the constitution of the user's dynamic key 15. The artificial intelligence interface significantly enhances the security of the platform.

Referring now to FIG. 2, at step 30 a user launches the network security application 2 or any other application such as a web browser or operating system (OS) that implements the network security application 2. Step 31 is the first biodynamic evaluation of the person holding or using the computer, tablet or other smart device. The first biodynamic evaluation is based one or more of motion, orientation or pressure sensor data that characterizes the user's use of the device or a comparable device. If this evaluation is failed, at step 32 the user is presented with a second biodynamic evaluation that will require the user to enter one or more strings of preselected characters and the captured and stored characteristics of the user's prior performance of the second biodynamic test constitutes the second biodynamic evaluation. The second biodynamic evaluation is based on pattern recognition data. For example, the pattern data that may be used may include keystroke timing, word timing, key pressure and speed and/or any other suitable parameter.

The credentialing step 33 initiates a dynamic pattern composition algorithm to complete the encryption/decryption key build. At step 34 the security application/browser/OS 2 transmits the encrypted personal key 10 to the security server 11 where it is decrypted. At step 35 the gatekeeper/manager 20 compares the decrypted personal key 10 to verify the user's identity.

Identity verification by the gatekeeper/manager 20 may also include confirmation that the user's personal key was generated by the correct user device. If the personal key is coming from an unknown device without an accompanying clearance code, the system assumes that the submission of the personal key is an attempt to spoof the user's identity. A clearance code may be any suitable code, unique to each user such as a 4-digit pin number. Alternatively, the user may be required to pass both the primary and/or secondary biodynamic evaluations to verify the user's identity from an unfamiliar device. The user's biodynamic data from a comparable device will be used to verify the user's identity. If the user is logging in from an unfamiliar smartphone the user's biodynamic data from the user's primary smartphone will be used to verify the user's identity. Similarly if the user is logging in from an unfamiliar tablet or iPad® the user's biodynamic data from the user's primary tablet or iPad® will be used to verify the user's identity. If this is the first instance of the user logging in from an unfamiliar device the user may be required to log in on their primary device and inform the security server that they wish to log in from a new device and request a clearance code for the new device. If the user is unable to log in from their primary device the unfamiliar device login may be refused to prevent a security breach.

At step 36 the gatekeeper/manager 20 combines the decrypted personal key 10 with its corresponding secondary personal key 12 to form composite key 14. At step 37 the gatekeeper/manager uses the composite key to retrieve the user's latest dynamic key 15 from the security database 16. At step 38 the gatekeeper/manager encrypts and sends the user's composite and the latest dynamic keys to the security application 2. At step 39 the user's ID has been verified and the user is granted access to the secure system/network. With secure access, the user is free to use and or access network resources at step 40 commensurate with the user's network rights.

When the user logs out of the network/browser/OS at step 41, the gatekeeper/manager 20 updates the user's dynamic key, personal key and secondary personal key using the user's updated network data at step 42, and then at step 43 encrypts and transmits the updated personal key to the computing device such as computer 7 for the user's next network session.

The User's biodynamic data is linked to the users digital identity and the biodynamic data will be different for each device the user utilizes to access the secure server. As a consequence, each user will have a different personal key for each device the user uses to access the secure server.

The first time the user launches the network security application 2, the user will be provided with a verification code for the user to confirm his identity to the security server 11. The verification code is a single use password unique to the software that is loaded on the user's device to verify the user's identity to the security server for the first use. Once the user's identity is temporarily verified, the users device such as smart watch 3 begins compiling the users motion, orientation or pressure sensor data 28 that will be used for future confirmation of the first bio evaluation 31. If this log-in is an initial log in from a new device, the user will also be required to enter one or more strings of letters, characters, words and common phrases to compile the user's device pattern recognition data 29 that may be used for the second biodynamic evaluation 32 in the event the user is unable to pass the first bio evaluation 31 or as an alternative to the first biodynamic evaluation.

Over time as the user interacts with the security application 2, there is increased behavioral pattern recognition learning from the captured and compressed user thumbnail summary 22 and the weighted activity dimensions 26. The dynamic pattern composition algorithms and the neural network 25 send the weighted activity dimensions 26 to the gatekeeper/manager 20. The combination of the gatekeeper/manager 20 and neural network 25 operate as a kind of virtual brain to deposit selected user data to the security database 16. This enables machine learning of the neutral network, capturing personalized attributes and patterns from the user and thus contributing added complexities to the biophysical security of the system. Pattern recognition by the neural network 25 may be used for developing and changing the user's dynamic key 15.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method for a user's security and identity verification on a computing device comprising the steps:
creating a digital signature using fixed user data;
capturing user biodynamic data corresponding to at least one of motion, orientation or pressure sensor data that characterizes the user's use of the computing device;
creating a biodynamic key using the captured biodynamic data;
incorporating the biodynamic key with the digital signature to create a personal key;
encoding and sending the personal key to a security server;
decoding the personal key at the security server and comparing the personal key to a secondary personal key;
if the personal key and the secondary personal key correspond, combine the personal key and the secondary personal key to form a composite key;
use the composite key to retrieve a dynamic key from the security server;
encode and send the composite key and the dynamic key to the computing device with an authentication verification.

2. The method of claim 1 further comprising the step of updating the user's personal key with data from each use of the computing device.

3. The method of claim 2 further comprising the step of updating the user's secondary personal key with data from each use of the computing device.

4. The method of claim 2 wherein the data from each use of the computing device further comprises the user's network data.

5. The method of claim 3 wherein the data from each use of the computing device further comprises the user's network data.

6. The method of claim 4 wherein the data from each use of the computing device further comprises activity dimensions.

7. The method of claim 5 wherein the data from each use of the computing device further comprises activity dimensions.

8. The method of claim 1 further comprising the step of:
capturing user's device pattern recognition data;
wherein the step of creating a biodynamic key using the captured biodynamic data further comprises incorporating the biodynamic data and the user's device pattern recognition data to create a biodynamic key.

9. The method of claim 8 wherein the user's device pattern recognition data comprises:
measured speed, timing and pressure of keystrokes made by the user entering one or more preselected strings of characters.

10. The method of claim 1 wherein the dynamic key is created including at least one selected from the following:
the user's device log data, the user's network text data, the user's network image data, compressed user network data and or weighted activity dimensions.

11. The method of claim 10 wherein the weighted activity dimensions include at least one selected from the following:
the number of friends associated with the user, the number of followers associated with the user, the number of other users linked to the user, the number of network sites visited by the user, a total of time spent on one or more preselected sites by the user, a total of time spent on one or more preselected network pages by the user, a numerical representation of content uploaded to the network by the user, a number representing the frequency of network usage by the user, a number representing the total duration of network usage by the user or the user's device log file.

12. The method of claim 1 wherein the fixed user data for the digital signature uses at least two selected from the following:
the user's full name, the user's mother's maiden name, the user's mother or father's city of birth, the user's city of birth, the user's date of birth, the user's day of birth and/or the user's birth gender.

13. The method of claim 1 further comprising the step of updating the user's personal key and the user's secondary personal key and the user's dynamic key with the user's network data and activity dimensions.

14. A method for a user's security and identity verification on a computing device comprising the steps:
creating a digital signature using at least two selected from the following:
the user's full name, the user's mother's maiden name, the user's mother or father's city of birth, the user's city of birth, the user's date of birth, the user's day of birth and/or the user's birth gender;
capturing user biodynamic data corresponding to motion, orientation or pressure sensor data that characterizes the user's use of the computing device;
capturing user's device pattern recognition data consisting of at least one of the following:
measured speed, timing or pressure of keystrokes made by the user entering one or more preselected strings of characters;
creating a biodynamic key using the captured biodynamic data and device pattern recognition data;
creating a personal key using the digital signature and the biodynamic key;
creating a dynamic key using at least one of the following:
the user's device log data, data representing the user's network text entries, data representing the user's network image entries, compressed user network data and or weighted activity dimensions wherein the weighted activity dimensions include at least one selected from the following:
the number of friends associated with the user, the number of followers associated with the user, the number of other users linked to the user, the number of network sites visited by the user, a total of time spent on one or more preselected sites by the user, a total of time spent on one or more preselected network pages by the user, a numerical representation of content uploaded to the network by the user, a number representing the frequency of network usage by the user, a number representing the total duration of network usage by the user or the user's device log file;
encoding and sending the personal key to a security server;
decoding the personal key at the security server and comparing the personal key to a secondary personal key;
if the personal key and the secondary personal key correspond, combine the personal key and the secondary personal key to form a composite key;
use the composite key to retrieve the dynamic key from the security server;
encode and send the composite key and the dynamic key to the computing device with an authentication verification; and
updating the user's personal key and the user's secondary personal key and the user's dynamic key with the user's network data and activity dimensions.
